(19) United States
(12) Patent Application Publication
(10) Pub. No.: US 2026/0244843 A1
(43) Pub. Date: Aug. 20, 2026

(54) ITERATIVELY GENERATING ENHANCED WRITING CONTENT FOR REAL-TIME CUSTOMIZABLE REFINEMENT

(71) Applicant: Bold Limited, Hamilton (BM)

(72) Inventors: Nilesh SRIVASTAVA, Noida (IN); Shailesh KRISHNA, Ghaziabad (IN); Laura HOWARD, San Francisco, CA (US); Mohit KUMAR GOEL, Greater Noida (IN)

(21) Appl. No.: 19/058,743

(22) Filed: Feb. 20, 2025

(51) Int. Cl. G06F 40/166; G06F 3/04817; G06F 3/0482

(52) U.S. Cl. CPC G06F 40/166; G06F 3/04817; G06F 3/0482

(57) ABSTRACT

Certain aspects of the disclosure provide a method for generating iteratively modified writing content. In aspects, the method includes receiving a request to enhance writing content from a user of a document-editing application; generating a first prompt chain configured to cause a language model to generate a modified version of the writing content, the first prompt chain comprising: a first prompt for generating an intermediate modified version of the writing content based on the writing content and an associated industry; and a second prompt for generating the modified version of the writing content; providing the first prompt chain to the language model; receiving the modified version of the writing content from the language model; storing the modified version of the writing content; and providing the modified version of the writing content to the user of the document-editing application within a list of selectable versions of the writing content.

### INTRODUCTION

### Technical Field

Aspects of the present disclosure relate to systems and methods for generating iteratively modified writing content.

### Background

Writing assistance systems are increasingly relied upon by users to enhance the quality of writing content. Writing assistance systems may streamline an aspect of a writing process by applying or recommending modifications to improve input writing content. For example, a writing assistance system may include a tool for helping a user improve their resume by assisting with incorporating proper grammar and punctuation. A different writing assistance system may include tools or features designed to provide formatting suggestions to improve the look and feel of input writing content. There is an opportunity to provide improved writing assistance systems for helping users enhance the quality of their writing content.

### SUMMARY

One aspect provides a method for generating iteratively modified writing content, the method including: receiving a request to enhance writing content from a user of a document-editing application; generating a first prompt chain configured to cause a language model to generate a modified version of the writing content, the first prompt chain comprising: a first prompt for generating an intermediate modified version of the writing content based on the writing content and an associated industry; and a second prompt for generating the modified version of the writing content based on the intermediate modified version of the writing content and a set of best practices of the associated industry; providing the first prompt chain to the language model; receiving the modified version of the writing content from the language model; storing the modified version of the writing content; and providing the modified version of the writing content to the user of the document-editing application within a list of selectable versions of the writing content.

Other aspects provide processing systems configured to perform the aforementioned method as well as those described herein; non-transitory, computer-readable media comprising instructions that, when executed by a processors of a processing system, cause the processing system to perform the aforementioned method as well as those described herein; a computer program product embodied on a computer readable storage medium comprising code for performing the aforementioned method as well as those further described herein; and a processing system comprising means for performing the aforementioned method as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example environment for implementing a writing enhancement system according to one or more aspects shown and described herein.

FIG. 2 depicts an example process implementable by a writing enhancement system for generating iteratively modified writing content according to one or more aspects.

FIG. 3 depicts an example process implementable by an example language model for executing a prompt chain generated by a writing enhancement system according to one or more aspects.

FIG. 4 depicts an example process implementable by a writing enhancement system for generating iteratively modified writing content according to one or more aspects.

FIG. 5 depicts an example user interface provided by a writing enhancement system for performing processes of generating iteratively modified writing content according to one or more aspects.

FIG. 6 depicts an example user interface including a list of selectable versions of modified writing content provided by a writing enhancement system when performing processes of generating iteratively modified writing content according to one or more aspects.

FIG. 7 depicts an example method for generating iteratively modified writing content implementable by a writing enhancement system according to one or more aspects.

FIG. 8 depicts an example processing system for enabling a writing enhancement system for performing processes of generating iteratively modified writing content according to one or more aspects.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for generating iteratively modified writing content. For example, described aspects may include a writing enhancement system implemented as a document-editing application for enabling a user to send a request to enhance a professional summary extracted from their professional resume. Described aspects are configured to generate specially designed prompt chains for causing a language model to generate and return modified versions of input writing content based on executing instructions for leveraging relevant context, including, for example, a determined relevant associated industry.

A language model is generally a type of machine learning model that is designed to understand, generate, and manipulate human language. More specifically, a language model is a probabilistic framework that determines the likelihood of a sequence of words or tokens. At its core, a language model attempts to predict the probability of the next word in a sentence given the preceding words. The model estimates these probabilities based on the patterns it learned during training. Language models are useful in natural language processing (NLP) and computational linguistics for performing a range of tasks involving human language, such as those described herein.

Language models may be characterized by various components and capabilities. For example, a language model may include a vocabulary that defines the set of all possible words or tokens that the model can recognize and use. This includes common words, punctuation, and possibly domain-specific jargon. Language models may also consider a context, which includes to the preceding words in a sentence or sequence that the model uses to predict the next word. Language models often incorporate extensive context windows, leveraging entire sentences or even paragraphs.

Language models may be implemented in various ways. For example, N-gram models predict the next word based on the previous N-1 words. Neural network-based language models include Recurrent Neural Networks (RNNs), Long Short-Term Memory (LSTM) networks, and more Transformer models. These models capture more complex language patterns and context dependencies. The transformer architecture, introduced with models like BERT and GPT, utilizes self-attention mechanisms to handle long-range dependencies potentially more effectively than RNNs or LSTMs.

Language models are often trained using large corpora of text. The training process involves adjusting the model's parameters to minimize the difference between its predicted word probabilities and the actual word sequences in the training data. This is typically done via techniques like maximum likelihood estimation and gradient descent.

Language models have a wide array of applications, including: text generation (e.g., producing coherent and contextually appropriate text); machine translation (e.g., converting text from one language to another); speech recognition (e.g., converting spoken language into text); text summarization (e.g., condensing a long piece of text into a shorter summary); sentiment analysis (e.g., determining the sentiment expressed in a piece of text); and question answering (e.g., automatically providing answers to questions posed in natural language).

Thus, a language model is a sophisticated tool in NLP that analyzes and generates human language by understanding the probabilistic relationships between words and leveraging large datasets to learn these relationships. They form the backbone of many modern NLP applications, enabling machines to interpret, generate, and interact with human language.

Described aspects utilize language models for generating iteratively modified writing content, thereby providing structured and comprehensive writing enhancement for writing content that is structured, professional, and context-specific.

In some examples, described aspects generate a first prompt configured to cause a language model to generate an intermediate modified version of writing content based on an associated industry. A second prompt generated by described aspects is configured to cause the language model to further refine the intermediate modified version to ensure a set of best practices of the associated industry are followed when generating a modified version of writing content. Modified versions of the writing content are then provided to a user within a list of selectable versions of the writing content via a suitable user interface provided by described aspects. The user interface provided by described aspects further enables the user to edit any selectable version of the writing content before submitting a next request to further enhance the writing content.

Certain conventional techniques for enhancing writing content rely on manual review and editing by individuals or teams, leading to inconsistent results that are time-consuming, resource-intensive, and prone to human error. Other conventional techniques for enhancing writing content employ automated tools that address a narrow set of writing features (e.g. grammar or style checking tools) rather than enhancing overall professionalism of writing content. Automated tools for enhancing writing further lack capabilities for iteratively enhancing writing based on user edits. Some conventional techniques instead rely upon predefined templates for enhancing writing content. For example, an organization may employ a predefined template for standardizing manual or automated creation of professional summaries based on a user's professional resume. However, conforming writing content to a predefined template lacks flexibility for adapting to unique context or user-specific needs for enhancing writing content.

Aspects described herein provide a technical solution for the aforementioned technical problems by providing systems and methods for generating iteratively modified writing content. In particular, described aspects generate specially designed prompt chains for causing a language model to generate a modified version of writing content that is both professional and tailored to the input writing content, thereby overcoming shortcomings of conventional techniques for enhancing writing content that lacks flexibility for adapting to unique context. For example, prompt chains generated in accordance with described aspects may be configured to cause a language model to consider an associated industry and a set of best practices corresponding to the associated industry for the writing content being enhanced. Described aspects further provide users with improved customizability and flexibility when enhancing writing content. For example, described aspects provide a user with a list of selectable versions of the writing content being enhanced, thereby providing a user the flexibility to visually monitor the evolution of their writing content over time through multiple rounds of modifications. In addition, described aspects further enable a user to dynamically edit any selected version of modified writing content in real-time, improving upon the lack of adaptability of conventional techniques for enhancing writing content with respect to incorporating user-specific modifications. The user may then submit iterative requests to enhance the writing content using described aspects, thereby providing the user with improved control and customization as compared to conventional techniques for enhancing writing content.

Described aspects for generating iteratively modified writing content further provide for various technical benefits. As an example, by storing each generated modified version of writing content for providing to the user within a list of selectable versions of the writing content, described aspects provide the benefit of improved version control and history tracking. Storing each modified versions provides additional functionality for comparing different versions, reverting to previous iterations, and tracking of modifications over time while simultaneously providing the technical benefit of reducing and/or preventing content loss as the writing content is iteratively enhanced. Described aspects are further configured to generate iteratively modified writing content using techniques that may be employed as a cloud-based system that utilizes language models, thereby providing the technical benefit of reducing computational cost and memory usage for local devices employed by the user to interface with described aspects as compared to conventional techniques provided through desktop applications or browser extensions.

### Example Systems and Methods for Generating Iteratively Modified Writing Content

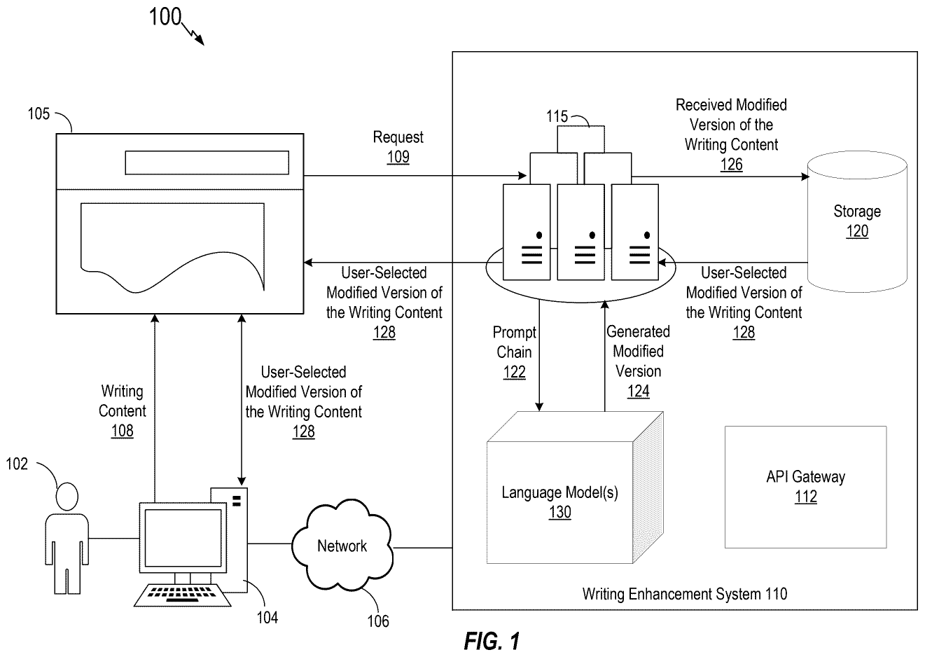

FIG. 1 depicts an example environment 100 for implementing a writing enhancement system 110 according to one or more aspects shown and described herein.

Writing enhancement system 110 may be implemented as an application for enabling a user to create and edit writing content. In certain aspects, writing enhancement system 110 may be implemented as a web-based document-editing application for enabling a user to create, edit, and iteratively modify professional documents, such as professional resumes. In certain aspects, writing enhancement system 110 is implemented as a web-based application or platform that enables registered users to create professional user profiles. In some examples, writing content associated with a professional user profile may be stored within a storage 120 of writing enhancement system 110. Storage 120 may include any local or cloud-based storage for storing large volumes of writing content. In response to receiving a user request to modify writing content, writing enhancement system 110 may then extract stored writing content from storage 120 for performing described techniques for generating iteratively enhanced writing content.

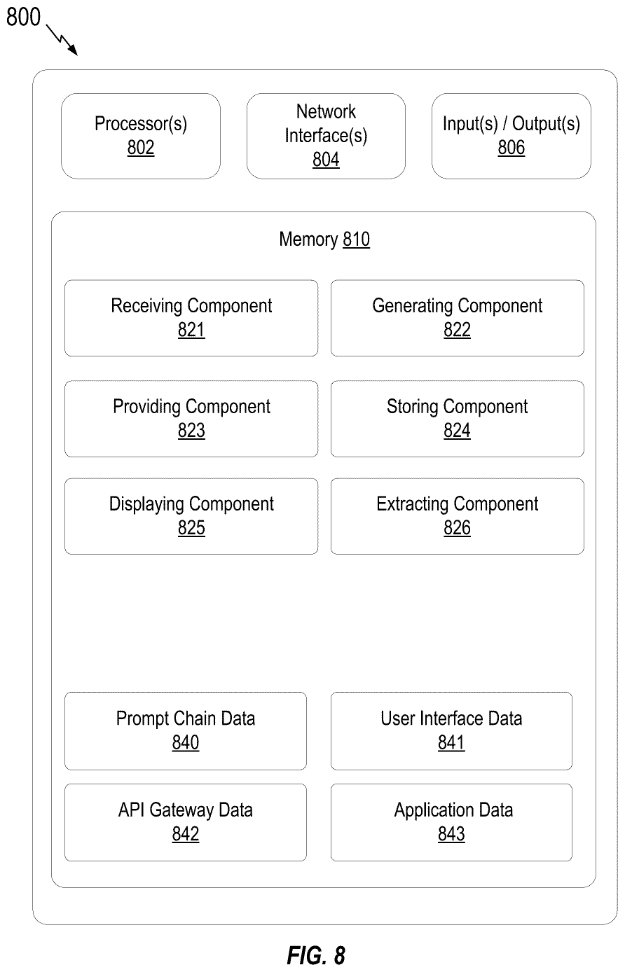

Writing enhancement system 110 may be implemented by one or more processing systems 115 (described in greater detail below with reference to processing system 800 of FIG. 8) including one or more processors and one or more non-transitory computer-readable mediums storing computer readable instructions that, when executed by the one or more processors, cause the one or more processing systems to perform processes defined by computer-readable instructions corresponding to one or more components depicted and described herein.

A user 102 may interface with aspects of writing enhancement system 110 through a device 104. In certain aspects, device 104 may be a personal computer, a tablet computer, a smart device (e.g., a smartphone), or the like. Device 104 may access writing enhancement system 110 via any suitable data network 106, including personal area networks (PANs), local area networks (LANs), wide area networks (WANs), the Internet, and the like.

In certain aspects, device 104 includes a display device for implementing a user interface with the respective user 102, one or more processors for executing logic and one or more non-transitory computer-readable mediums for storing information and/or computer readable instructions. In certain aspects, device 104 operates as an interface for interacting with writing enhancement system 110 via a user interface 105 provided by writing enhancement system 110. For example, user 102 may utilize device 104 to manually input writing content 108 into user interface 105. User 102 may then send a request 109 to writing enhancement system 110 to generate a modified version of the writing content 108.

In certain aspects, to perform processes described herein, writing enhancement system 110 is further configured to communicate with and leverage language model(s) 130, such as one or more artificial intelligence-based machine learning models that may include, but are not limited to, language models such as OpenAI's ChatGPT, NeMO™ LLM from NVIDIA®, LLaMa from Meta®, BERT from Google®, CLAUDE™ from Anthropic A.I., and FLAN-T5 form Google®. Components of the processes described herein can implement one or more language models currently developed or that may be developed in the future. In certain aspects, language model 130 is installed and hosted locally within writing enhancement system 110. In other aspects, language model 130 is called using an application programming interface (API), such as via calls performed by an API gateway 112 of writing enhancement system 110.

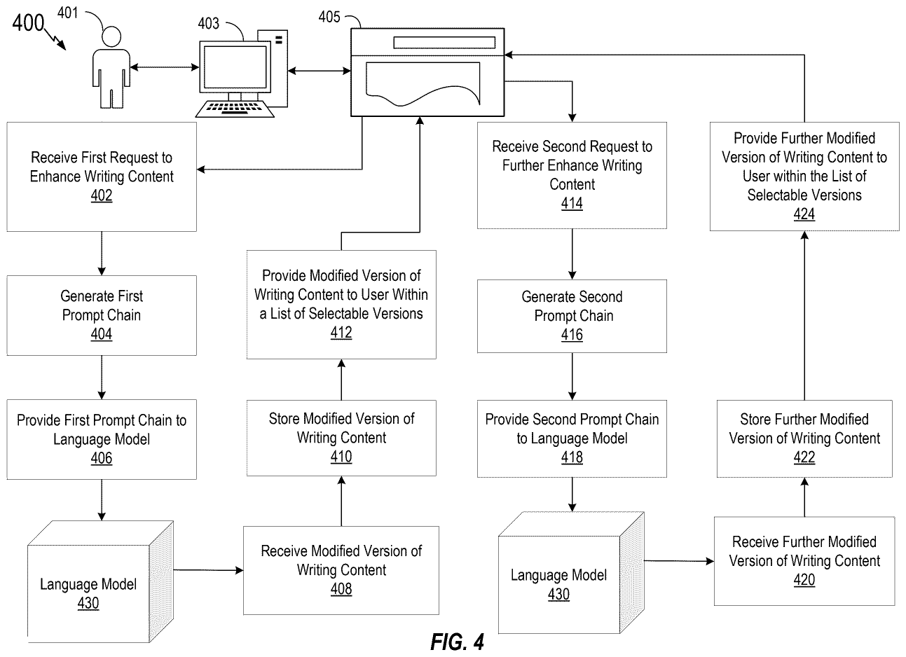

Writing enhancement system 110 is configured to generate a prompt chain for causing language model 130 to generate a modified version of writing content 108 that user 102 has requested to be enhanced. In aspects, a first generated prompt of the prompt chain is configured to cause language model 130 to generate an intermediate modified version of writing content based on an associated industry for the writing content, thereby ensuring that the generated intermediate modified version of the writing content includes language that is informed by a relevant professional industry. A second prompt generated by described aspects is configured to cause the language model(s) to further refine the intermediate modified version of the writing content to ensure a set of best practices for the associated industry are followed when generating a modified version of writing content for returning to user 102, for example, as shown in example process 400 described below with reference to FIG. 4. The writing enhancement system provides the prompt chain 122 to language model 130. After processing the prompt chain, a generated modified version of the writing content 124 is then returned from the language model 130 to writing enhancement system 110. Writing enhancement system 110 thus utilizes automated techniques implemented as a cloud-based system for generating prompts configured to cause language model 130 to generate and return enhanced writing content. When utilizing a cloud-based implementation, writing enhancement system 110 further provides the technical benefit of reducing computational cost and memory usage for local devices employed by user 102 (such as device 104) to interface with writing enhancement system 110 as compared to conventional techniques provided through desktop applications or browser extensions.

Writing enhancement system 110 may store each received modified versions of writing content 126 within storage 120. Writing enhancement system 110 may further be configured to display each modified version of the writing content to user 102 within, for example, a drop-down menu or other user interface element, of user interface 105. User 102 may then navigate between modified versions of the writing content, iteratively editing and requesting further enhancement of the writing content until a version of the writing content is approved by the user. For example, writing enhancement system 110 may fetch a user-selected modified version of the writing content 128 from storage 120, and provide it to user 102 via the user interface 105. Upon viewing the provided user-selected modified version of the writing content, user 102 may optionally edit the writing content further before choosing to approve the writing content, or submit a next iterative request to generate an additional modified version using writing enhancement system 110. By storing each modified version of the writing content within storage 120, described aspects further provide improved version control and history tracking, enabling users to more efficiently track evolution of the document overtime, or to more easily revert to a previous version if a user is dissatisfied with changes to the writing content over time. By ensuring each modified version is safely stored and maintained, writing enhancement system 110 provides user 102 with increased flexibility and customization in creating and editing professional writing content while providing the technical benefit of reducing accidental loss of writing content during complex and iterative editing processes.

The hybrid approach provided by writing enhancement system 110 thus combines automated techniques for leveraging specially designed prompts with enabling users to dynamically manage and edit professional writing content. Writing enhancement system provides users the flexibility to edit and refine their writing content while simultaneously providing automated and scalable writing enhancement through generation of prompt chains for returning modified versions of the writing content that are structured and informed by relevant context. This hybrid approach provides the advantages of automation without sacrificing the flexibility of personalized, context-specific modifications, thereby overcoming shortcomings of conventional techniques that employ rigid template-based or solely automated solutions.

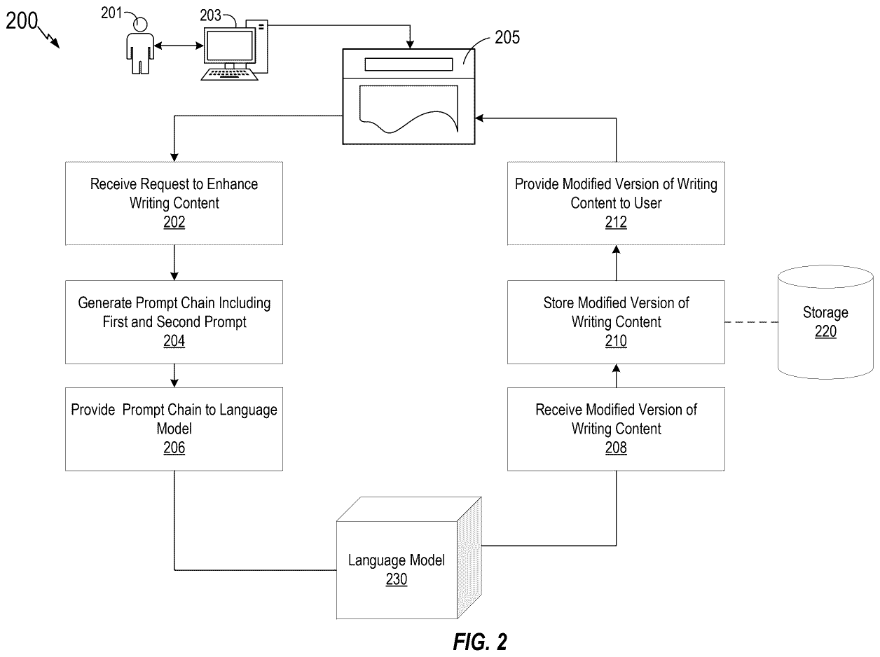

FIG. 2 depicts an example process 200 implementable by a writing enhancement system for generating iteratively modified writing content according to one or more aspects.

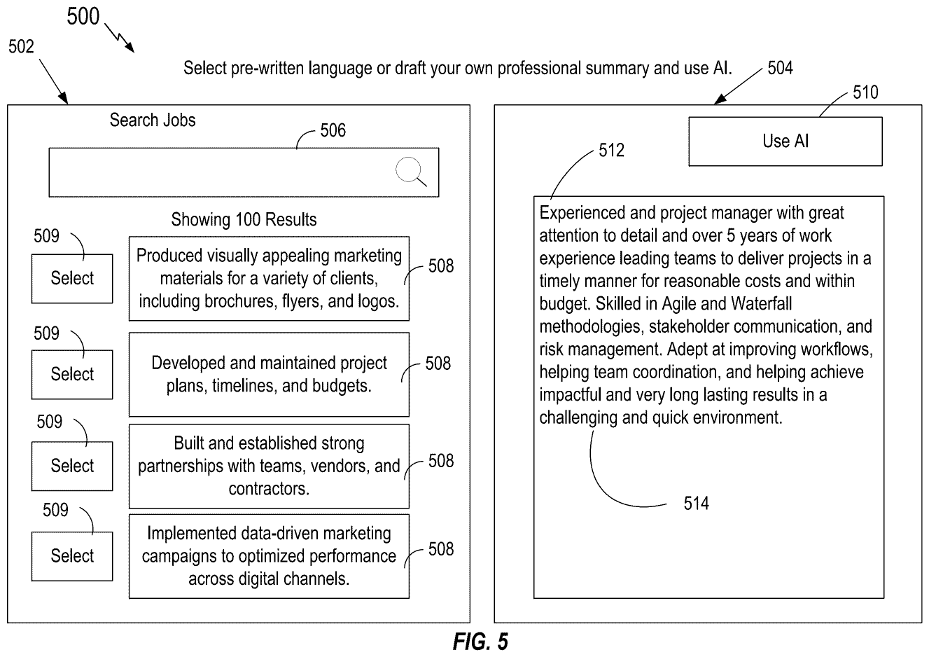

At block 202, the writing enhancement system receives a request to enhance writing content, for example, using receiving component 821 described below with reference to FIG. 8. For example, the writing enhancement system may be implemented as a document-editing application configured to provide a user interface 205 for enabling user 201 (e.g. a registered user of the document-editing application) to select an icon for requesting enhancement of input writing content (such as selectable icon 510 of user interface 500 described below with reference to FIG. 5). At certain times, user 201 may manually provide writing content to be enhanced, such as by manually inputting writing content (e.g. via typing) into a window of the provided user interface using a device 203 (for example, similar to device 104 described above with reference to FIG. 1). In some aspects, the writing enhancement system may be configured to extract (for example, using an extracting component 826 described below with reference to FIG. 8) writing content from a professional user profile or professional document (such as a resume) associated with a registered user of the writing enhancement system, such as user 201. For example, the writing enhancement system may extract a professional summary from a stored resume or professional profile (such as a resume or professional user profile stored within storage 120 as described above with reference to FIG. 1) associated with user 201.

At block 204, in response to receiving the request to enhance writing content, the writing enhancement system generates a prompt chain including a first and second prompt, for example, using a generating component 822 described below with reference to FIG. 8. In certain aspects, the first and second prompt of the prompt chain are generated using one or more respective prompt templates. As used herein, a “prompt template” refers to a structured framework for generating one or more prompts of a prompt chain that include a set of instructions and a set of placeholders for inputting variable information, thereby enabling customization for each prompt of a prompt chain based on specific inputs. For example, a prompt template may include placeholders for different types of extracted writing content. A prompt template may further include placeholders for a determined associated industry to be leveraged as context for carrying out the set of instructions.

In one example, the first generated prompt of the prompt chain may include instructions for causing a language model (such as a language model 230) to determine an associated industry for the writing content contained within the first prompt that is being modified. For example, the first prompt may include instructions specifying an input format (e.g. a professional summary, a skills section of a resume, etc.), an output format for returning an associated industry for the writing content, and a set of features to be considered for determining an associated industry, such as based on one or more of keywords, role descriptions, or context within the input writing content. The instructions for causing the language model to determine an associated industry for the writing content within the first prompt may be contained within a first portion of the first prompt, such that the determined industry can be utilized as context for processing subsequent portions of the first prompt.

In aspects, the generated first prompt further includes additional instructions for improving writing content based on a set of best practices corresponding to the determined associated industry for the writing content. As used herein a “set of best practices” refer to one or more of industry-specific guidelines, methodologies, and standards tailored to a particular field.

For example, the set of best practices may include industry-specific terminology, tone, and focus areas (e.g. quantifiable achievement for finance industry writing, customer-centric language for retail writing, etc.) for improving the input writing content. As an example, additional instructions in the first generated prompt may state:
Refine the input professional summary using the following set of best practices for the associated industry of healthcare: Use relevant healthcare-specific terminology and highlight healthcare-specific key skills, quantify achievements and include measurable outcomes, and tailor the tone and focus of the writing content to focus and match healthcare industry standards.

The first generated prompt may include additional instructions for leveraging a wide variety of different best practices corresponding to an associated industry for the writing content, which may include, but are not limited to, best practices related to industry-specific guidelines, industry-specific expectations or valued outcomes (e.g. healthcare industry may emphasize compliance, patience outcomes, etc.), industry-specific metrics (e.g. reducing “downtime” for information technology industry), industry-specific roles and terminology, and industry-specific tone and style (e.g. professional and precise for finance, collaborative and user-focused for marketing, etc.).

The generated first prompt may further include instructions for enhancing professional tone of input writing content to be enhanced. As used herein “professional tone” refers to a formal writing style that uses precise industry-specific language to convey expertise and value to potential employers. As an example, the first prompt may include instructions for enhancing professional tone by improving conciseness, such as by removing redundancy or unnecessary details within writing content. In another example, the generated first prompt may include instructions for improving clarity by using language that is simple and precise to improve readability and understanding from the perspective of a reader. In yet another example, the generated first prompt may further include instructions for improving correctness of input writing content by aligning the language and terminology of the writing content with conventions of the determined industry. The generated first prompt may further include instructions for adding outcome-focused language that highlights results and value (e.g., “high satisfaction rates”, “long-term client relationships”, etc.) to a potential employer for a particular relevant industry.

In some examples, the first prompt further includes instructions for enhancing impact of the writing content, such as by refining one or more of the language, structure, or tone of the writing content to make the writing content more engaging, persuasive, and memorable from the perspective of a reader. For example, instructions for enhancing impact of the writing content may include instructions for inserting stronger verbs, such as replacing a generic verb “leading” with “orchestrating” to convey a sense of strategic coordination. In another example, instructions for enhancing impact may include adding words for conveying specificity for a given phrase, such as adding the word “cross-functional” to the phrase “managed multiple teams” to generate a more impactful statement “managed multiple cross-functional teams” to highlight the ability of the user to work across diverse groups.

In other aspects, additional instructions may be added or substituted into the first generated prompt as may be advantageous for transforming the input writing content. The instructions within the first generated prompt may each be configured to ensure that the generated outputs align with an included set of best practices corresponding to the determined associated industry for the writing content, thus ensuring consistent high-quality outputs that are context-specific.

The first generated prompt may further include additional instructions for applying generic modifications to enhance the professionalism of the input writing content regardless of the associated industry. For example, the first generated prompt may include instructions for correcting spelling errors and punctuation mistakes, ensuring proper capitalization, eliminating any use of first-person pronouns (e.g. “I” or “my”), and for causing any other advantageous modifications to the input writing for promoting a proper foundation for improving the writing content.

The generated first prompt described above is configured to cause language model 230 to generate an intermediate modified version of the input writing content. The second prompt generated by the writing enhancement system is configured to then incorporate the generated intermediate modified version of the writing content as an input for generating a modified version of the writing content to return to user 201. In certain aspects, the generated second prompt includes instructions for refining the language of the modified intermediate version of the writing content to further enhance professionalism, align with the set of best practices for the determined associated industry, and ensure formal resume standards are followed. For example, the second prompt may include instructions to cause the language model to determine that one or more words of the intermediate modified version of the writing content conflict with the set of best practices, thereby causing the language model to further modify the intermediate writing content. The writing enhancement system thus generates a second prompt that is usable for sequential refinement to fine-tune the intermediate modified version of the writing content for ensuring that the quality of outputs generated by language model 230 does not drop in view of the breadth and complexity of the context contained within the first generated prompt.

At certain times, the generated first prompt may include a complex set of numerous features, thereby increasing the risk of language model 230 generating outputs of reduced quality based on accidental misinterpretation or errors in processing the first generated prompt due to the complexity and quantity of features therein. Sequential prompting, such as using the generated second prompt, functionally focuses the language model on certain manageable steps involving smaller subsets of information, thereby reducing the risk of misinterpretation, context dilution, or instruction overload by the language model when generating high quality outputs having features aligned with the set of tasks in the generated second prompt. The generated second prompt thus functions as a mechanism for improving the quality of the ultimate output by refining the intermediate modified version of the writing content to adhere to professional tone and style, align with the set of best practices, and conform to formal resume standards. Sequential prompting using the first and second prompt of the generated prompt chain thus provides the benefit of increasing output quality by providing a modular approach that focuses the language model on certain features at certain times during sequential prompting.

At block 206, the writing enhancement then provides the generated prompt chain to language model 230 for sequentially executing the first prompt and the second prompt of the generated prompt chain, for example, using providing component 823 described below with reference to FIG. 8. In certain aspects in which language model 230 is not locally hosted, the writing enhancement system may utilize an API call to provide (for example, using API gateway 112 described above with reference to FIG. 1) the generated prompt chain to a third-party language model.

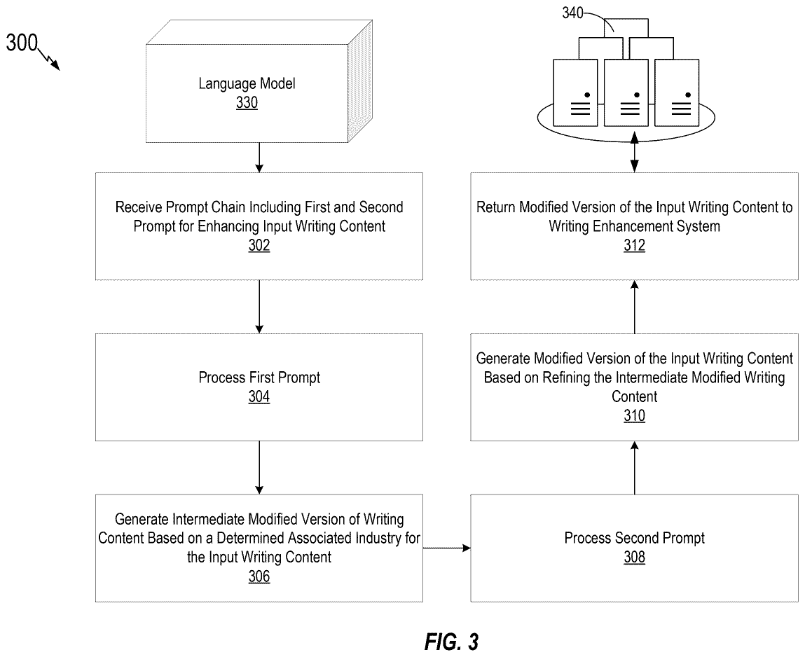

FIG. 3 depicts an example process 300 implementable by an example language model 330 for executing a prompt chain generated by a writing enhancement system (as described above) according to one or more aspects.

At block 302, language model 330 receives a prompt chain generated by a writing enhancement system according to one or more aspects, for example, as described above at block 204 of process 200 with reference to FIG. 2. As discussed above, the received prompt chain includes at least a first and a second prompt to be sequentially executed by language model 330 to generate modified writing content based on a user request. As an example, the first prompt chain sent to language model 330 may be designed to cause language model 330 to modify writing content including a professional summary stating the following:
Confident senior floor manager successful at increasing monthly revenue using insightful marketing strategies and extensive product development. Skilled at understanding customer and employee requests and meeting needs. Furthers success by strengthening staff training, streamlining internal systems and facilitating sales techniques.

At block 304, language model 330 processes the first prompt of the received prompt chain. As discussed above, when processing a first portion of the first prompt, language model 330 may determine an associated industry for the writing content contained therein for leveraging during processing of one or more subsequent portions of the first prompt.

At block 306, language model 330 generates an intermediate modified version of the writing content contained within the first prompt. The intermediate modified version is generated based on the determined associated industry and various instructions contained within the first prompt. For the example writing content discussed above with reference to block 304, the generated intermediate modified version based on processing of the first prompt may include the following:
Confident senior floor manager with a proven track record of increasing monthly revenue through innovative marketing strategies and extensive product development. Expertise in identifying and addressing customer and employee needs to enhance satisfaction. Drives success by enhancing staff training, optimizing internal systems, and implementing effective sales techniques. Strong leadership abilities focused on achieving operational excellence and fostering a high-performance team environment.

The example intermediate modified version of the writing content includes modified writing content for improving impact, professional tone, and conformity with a set of best practices for senior floor managers. In other examples, additional or fewer modifications to the writing content may be made based on processing of the first prompt by language model 330.

At block 308, language model 330 then processes the second prompt of the received prompt chain. As previously discussed, the second prompt is configured to cause the language model to utilize the intermediate modified version generated, such as the intermediate modified version generated at 306, as input into the second prompt. The second prompt functions as a quality control mechanism to mitigate any misinterpretation, context dilution, or instruction overload that may have been experienced by language model 330 when generating the intermediate modified version. For the example intermediate modified version discussed at block 306, the generated second prompt may cause language model 330 to ensure that the intermediate modified version adheres to professional tone and style, aligns with the set of best practices, and conforms to formal resume standards.

At block 310, language model 330 generates a modified version of the input writing content based on further refining the generated intermediate modified version. As discussed above, the generated modified version of the input writing content may be refined based on the language model 330 aligning the writing content (from the generated intermediate version of the input writing content) with the set of best practices for the determined associated industry.

At block 312, language model 330 then returns the modified version to a receiving component (such as receiving component 821 of processing system 800 described below with reference to FIG. 8) of an example writing enhancement system 340 in accordance with described aspects.

Returning to process 200 of FIG. 2, at block 208, the writing enhancement system receives the modified version of the writing content generated by language model 230 by sequentially processing the first and second prompts of the generated prompt chain, for example, using receiving component 821 described below with reference to FIG. 8.

At block 210, the writing enhancement system then stores the modified version of the writing content, for example, using storing component 824 described below with reference to FIG. 8. In certain aspects, the writing enhancement system stores the modified version of the writing content within storage 220. In certain aspects, storage 220 may include one or more locally-hosted relational databases, NoSQL databases, object storage, or the like. In some examples, storage 220 may be cloud-based. In other aspects, the writing enhancement system is instead configured to store modified versions of the writing content locally within its own memory. In some examples, the writing enhancement system may store the received modified version of the writing content within an in-memory caching system for supporting lower latency returning of writing content to a user.

At block 212, the writing enhancement system provides the modified version of the writing content to user 201, for example, using providing component 823 described below with reference to FIG. 8. The writing enhancement system may provide the modified version of the writing content to a user via provided user interface 205.

As previously discussed, writing enhancement systems is further configured to enable users to users to dynamically manage and edit professional writing content as it is automatically modified and returned based on processing of the specially designed prompts described above.

FIG. 4 depicts an example process 400 implementable by a writing enhancement system for generating iteratively modified writing content according to one or more aspects. Certain steps of process 400 are substantially similar to those described above in connection with at least processes 200 of FIG. 2. More specifically, description of each of blocks 404-408 and blocks 416-420 of process 400 are substantially similar to previously described blocks 204-208 of process 200, and are therefore omitted below for conciseness and clarity.

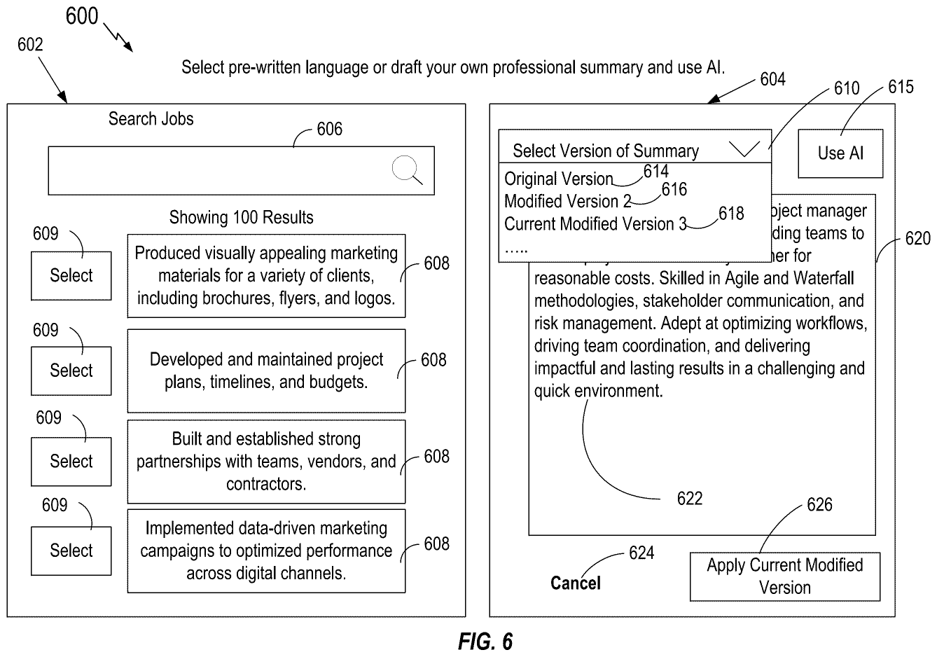

At block 402, the writing enhancement system receives a first request to enhance writing content. For example, the writing enhancement system may receive a request from a user 401 interfacing with a device 403 (such as a personal computer) to submit a request to enhance writing content via a user interface 405 provided by the writing enhancement system. Aspects of process 400 are further described with respect to the user interfaces 500 and 600 described below with reference to FIGS. 5-6.

FIG. 5 depicts an example user interface 500 provided by a writing enhancement system for enabling processes of generating iteratively modified writing content according to one or more aspects, for example using one or more of providing component 823 and displaying component 825 described below with reference to FIG. 8. User interface 500 is provided by a writing enhancement system to enable a user to iteratively modify writing content including professional summaries, such as for inclusion within a professional resume. User interface 500 includes a first window 502, and a second window 504. First window 502 includes a search bar 506 for enabling a user to search for relevant pre-written language associated with a given industry or job title. For example, the writing enhancement system may be configured to fetch professional excerpts stored within an accessible storage (such as storage 120 described above with reference to FIG. 1) Professional excerpts are then displayed within a series of windows 508 that a user may select by interacting with a corresponding selectable icon 509.

Within second window 504, an editing window 512 displays writing content 514. The writing content 514 may be manually input by a user, inserted based on a selection from first window 502, or extracted (for example, using extracting component 826 described below with reference to FIG. 8) from a professional user profile or resume by the writing enhancement system. Editing window 512 may be configured to enable the user to edit writing content 514 in real-time, such as by using peripherals (e.g. a keyboard, mouse, touch screen, voice transcription, etc.) compatible with a device (e.g. a personal computer) for enabling the user to interface with user interface 500. When a user wishes to modify writing content 514, they may interact with a selectable icon 510 to cause the writing enhancement system to perform described methods for generating iteratively modified writing content (for example, in accordance with processes 200 and 400 described herein with reference to FIG. 2 and FIG. 4 respectively).

Returning to process 400 and FIG. 4, at block 410, the writing enhancement system stores a modified version of the writing content received from a language model 430, for example, as described above in connection with process 200 with reference to FIG. 2. Block 404 may be performed using similar means as described above in connection with block 204 of process 200 with reference to FIG. 2. As previously discussed, the modified version may be stored within locally-hosted memory or an accessible storage component, such as using storage 220 described above with reference to FIG. 2.

At block 412, the writing enhancement system provides the modified version of the writing content to the user within a list of selectable versions, for example using providing component 823 described below with reference to FIG. 8. The writing enhancement system may be configured to fetch a stored modified version of the writing content, and then display (for example, using displaying component 825 described below with reference to FIG. 8) the list of selectable versions via provided user interface 405. User interface 405 enables the user 401 to interface with the writing enhancement system to navigate between displayed versions of the writing content and to perform dynamic edits to the writing content in real-time before optionally requesting further enhancement of the writing content. The writing enhancement system thus provides the user 401 with increased flexibility and customization in creating and editing their professional writing content through providing features such as improved version control and history tracking, the ability to revert to previous iterations, and the ability to tracking modifications over time. Writing enhancement systems in accordance with described aspects may continually store and maintain each modified version, thereby providing the technical benefit of reducing and/or preventing inadvertent content (e.g. by applying numerous changes over time without any mechanism for preserving prior versions) loss as the writing content is iteratively enhanced and dynamically edited by the user in real-time. The above-described features are further described with respect to the example user interface described in greater detail below.

FIG. 6 depicts an example user interface 600 including a list of selectable versions of modified writing content provided by a writing enhancement system performing processes of generating iteratively modified writing content according to one or more aspects. As shown, user interface 600 includes a list of selectable versions of modified writing content within a drop-down menu 610. The drop-down menu 610 of user interface 600 includes a first selectable version 614 corresponding to an “Original Version” that, when selected, displays the writing content prior to the writing enhancement system performing described processes for generating a modified version of the writing content. Drop-down menu 610 further includes a second selectable version 616 corresponding to a “Modified Version 2” of the writing content that, when selected, displays a first modified version of the writing content that has been generated and stored using techniques described above (such as using process 200 described above with reference to FIG. 2). A third selectable version 618 corresponds to a “Current Modified Version” 3 that, when selected, displays a most-recently modified version of the writing content. The selected version from drop-down menu 610 may be displayed as writing content 622 within editing window 620 of second window 604.

Once a user has selected a version to display within editing window 620, the user may dynamically edit the writing content 622 corresponding to the selected version. Writing enhancement systems in accordance with described aspects may be configured to provide an editing window for enabling a user to perform any known document-editing functionalities, such as being able to modify text, fonts, styles, formats, and any other text features the user may wish to customize for purposes of creating or modifying professional writing content. The user may further be able to edit the writing content 622 by utilizing the search bar 606 of first window 602 to select one or more professional excerpts 608 using one or more selectable icons 609 using similar means as described above with reference to user interface 500 of FIG. 5. To cancel the writing enhancement process and return to a previous window, the user may interact with a selectable icon 624 labeled “Cancel”. A user may interact with a selectable icon 626 labeled “Approve Current Modified Version” to approve the writing content 622 within editing window 620 to add the writing content to a professional document being created.

Alternatively, if a user remains unsatisfied with the writing content, or wishes to further improve the writing content 622 using automated processes provided by the writing enhancement system (for example, as described above in connection with process 200 with reference to FIG. 2), then the user may instead select an icon 615 labeled “Use AI” to once again cause the writing enhancement system to generate a prompt chain for causing the language model to generate and return a further modified version of the writing content. The further modified version of the writing content will similarly be stored and provided to the user within the list of modified versions of the writing content within drop-down menu 610. Accordingly, the writing enhancement system provides the user with hybrid functionality that combines automated techniques for leveraging specially designed prompts with enabling users to dynamically manage and edit professional writing content. The user is thus afforded the advantages of automation without sacrificing the flexibility of personalized, context-specific modifications, thereby overcoming shortcomings of conventional techniques that employ rigid template-based or solely automated solutions. User interface 600 is merely illustrative, and features may be added, removed, or substituted in alternative aspects.

Returning to process 400, at 414 the writing enhancement system receives a second request to further enhance the writing content. As described above in connection with user interface 600 of FIG. 6, after applying optional edits to the writing content, the user may send an additional request to further modify the writing content. The writing enhancement system will then again perform described processes (for example, as described above in connection with process 200 with reference to FIG. 2) for prompting the language model 430 to automatically generate and return a further modified version of the writing content.

At block 422, upon receiving the next modified version of the writing content, the writing enhancement system stores the further modified version of the writing content. For example, the writing enhancement system may store the further modified version of the writing content as described above in connection with block 204 of process 200 with reference to FIG. 2.

At block 424, the writing enhancement system provides the further modified version of the writing content to the user within the list of selectable versions, such as within the list of selectable versions contained within the drop-down menu 610 of user interface 600 described above with reference to FIG. 6. The user may then view the further modified version of the writing content to decide whether to approve the writing content, optionally edit the content, or optionally send an additional request to further enhance the writing content using the automated techniques, for example, as described above in connection with process 200 with reference to FIG. 2.

Process 400 is merely an example, and user 401 may further send additional or fewer requests to a writing enhancement system in accordance with described aspects for enhancing writing content. In certain aspects, the first prompt chain and second prompt chain are each generated using shared prompt templates, having the input writing content modified to reflect a specific modified version that is being refined. In other aspects, the writing enhancement system may be configured to utilize different prompt templates for generating each iteratively utilized prompt chain. Different prompt templates may include different sets of instructions for altering the writing features or tasks prioritized by a language model during the process of generating each modified version of the writing content.

### Example Method for Generating Iteratively Modified Writing Content

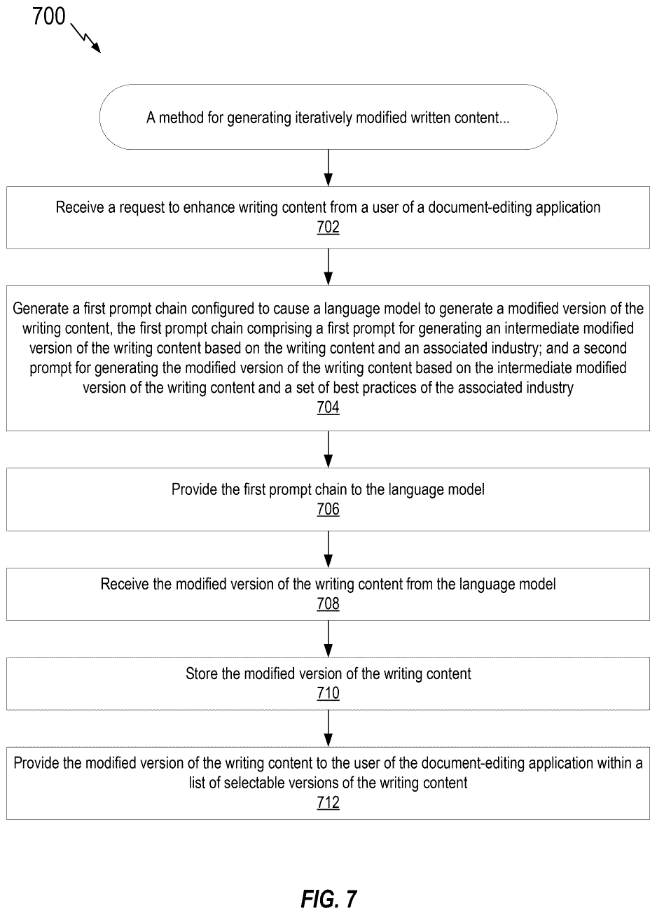

FIG. 7 depicts an example method 700 for generating iteratively modified writing content according to one or more aspects shown and described herein.

Method 700 begins at block 702 with receiving a request to enhance writing content from a user of a document-editing application. For example, block 702 may be performed by the one or more processing systems 800 described below with reference to FIG. 8, configured to implement components including, but not limited to, a receiving component 821.

Method 700 proceeds to block 704 with generating a first prompt chain configured to cause a language model to generate a modified version of the writing content, the first prompt chain comprising a first prompt for generating an intermediate modified version of the writing content based on the writing content and an associated industry; and a second prompt for generating the modified version of the writing content based on the intermediate modified version of the writing content and a set of best practices of the associated industry. For example, block 704 may be performed by the one or more processing systems 800 described below with reference to FIG. 8, configured to implement components including, but not limited to, a generating component 822.

Method 700 proceeds to block 706 with providing the first prompt chain to the language model. For example, block 706 may be performed by the one or more processing systems 800 described below with reference to FIG. 8, configured to implement components including, but not limited to, a providing component 823.

Method 700 proceeds to block 708 with receiving the modified version of the writing content from the language model. For example, block 708 may be performed by the one or more processing systems 800 described below with reference to FIG. 8, configured to implement components including, but not limited to, receiving component 821.

Method 700 proceeds to block 710 with storing the modified version of the writing content. For example, block 710 may be performed by the one or more processing systems 800 described below with reference to FIG. 8, configured to implement components including, but not limited to, a storing component 824.

Method 700 proceeds to block 712 with providing the modified version of the writing content to the user of the document-editing application within a list of selectable versions of the writing content. For example, block 712 may be performed by the one or more processing systems 800 described below with reference to FIG. 8, configured to implement components including, but not limited to, a providing component 823.

In some aspects, method 700 further includes receiving a second request from the user to further enhance the modified version of the writing content, wherein the received modified version of the writing content is edited prior to receiving the second request.

In some aspects, method 700 further includes generating a second prompt chain configured to cause the language model to generate a further modified version of the writing content based on the modified version of the writing content.

In some aspects, method 700 further includes providing the second prompt chain to the language model; receiving, the further modified version of the writing content from the language model; storing the further modified version of the writing content; and providing the further modified version of the writing content to the user of the document-editing application within the list of selectable versions of the writing content.

In some aspects, the first prompt includes instructions for causing the language model to: determine the associated industry for the writing content; and generate the intermediate modified version of the writing content based on a set of best practices corresponding to the determined associated industry.

In some aspects, the second prompt comprises instructions for causing the language model to: in response to determining that one or more words of the intermediate modified version of the writing content conflict with the set of best practices, further modify the intermediate modified version of the writing content to generate the modified version of the writing content.

In some aspects, the first prompt chain and the second prompt chain are generated using shared prompt templates.

In some aspects, the first prompt is further configured to cause the language model to enhance one or more of clarity, professional tone, and impact of the writing content.

In some aspects, the first prompt chain and the second prompt chain are provided to the language model via an application programming interface.

In some aspects, the list of selectable versions of the writing content is provided to the user of the document-editing application via a drop-down menu displayed within a user interface of the document-editing application.

In some aspects, method 700 further includes receiving a selected version of the writing content from the drop-down menu; displaying the selected version of the writing content to the user via the user interface of the document-editing application; and generating a selectable icon for applying the displayed selected version to the writing content upon activation of the selectable icon by the user

Method 700 thus provides technical solutions to overcome shortcomings of conventional techniques for generating enhanced writing content. Method 700 enables a user to dynamically edit any selected version of modified writing content in real-time, improving upon the lack of adaptability of conventional techniques for enhancing writing content with respect to incorporating user-specific modifications. The user may then submit iterative requests to enhance the writing content using automated techniques employing specially designed prompts. The hybrid approach combining automated prompting techniques with flexible version management and real-time editing capabilities provided by method 700 thereby provides users with improved control and customization as compared to conventional techniques for enhancing writing content. Further, by storing each modified versions and providing a convenient list of selectable versions, method 700 provides users with the ability to revert to previous iterations, and track modifications in writing content over time while simultaneously reducing and/or preventing loss of the writing content as it is iteratively enhanced over time. Described aspects are further configured to generate iteratively modified writing content using techniques that may be employed as a cloud-based system (e.g. such as via a web-based document-editing application) that utilize language models, thereby providing the technical benefit of reducing local computational cost and memory usage for local devices employed by the user as compared to conventional techniques provided through desktop applications or browser extensions.

FIG. 7 is just one example of a method, and other methods including fewer, additional, or alternative steps are possible consistent with this disclosure.

### Example Processing System for Generating Iteratively Modified Writing Content

FIG. 8 depicts an example processing system 800 upon which one or more aspects shown and described herein may be implemented.

The processing system 800 includes one or more processors 802. Generally, processor(s) 802 may be configured to execute computer-executable instructions (e.g., software code) to perform various functions, as described herein.

The processing system 800 further includes a network interface(s) 804, which generally provides data access to any sort of data network, including personal area networks (PANs), local area networks (LANs), wide area networks (WANs), the Internet, and the like.

The processing system 800 further includes input(s) and output(s) 806, which generally provide means for providing data to and from the processing system 800, such as via connection to computing device peripherals, including user interface peripherals.

The processing system 800 further includes a memory 810 configured to store various types of components and data.

In this example, memory 810 includes a receiving component 821, a generating component 822, a providing component 823, a storing component 824, a displaying component 825, and an extracting component 826.

Receiving component 821 may be configured to perform processes, for example, corresponding to blocks 702 and 708 of method 700 described above with reference to FIG. 7. Receiving component 821 may further be configured to perform processes, for example, corresponding to blocks 202 and 208 of process 200 described above with reference to FIG. 2, and blocks 402, 408, 414, and 420 of process 400 described above with reference to FIG. 4.

Generating component 822 may be configured to perform processes, for example, corresponding to block 704 of method 700 described above with reference to FIG. 7. Generating component 822 may further be configured to perform processes, for example, corresponding to block 204 of process 200 described above with reference to FIG. 2, and blocks 404 and 416 of process 400 described above with reference to FIG. 4.

Providing component 823 may be configured to perform processes, for example, corresponding to blocks 706 and 712 of method 700 described above with reference to FIG. 7. Providing component 823 may further be configured to perform processes, for example, corresponding to blocks 206 and 212 of process 200 described above with reference to FIG. 2, and blocks 406, 412, 418, and 424 of process 400 described above with reference to FIG. 4.

Storing component 824 may be configured to perform processes, for example, corresponding to block 710 of method 700 described above with reference to FIG. 7. Storing component 824 may further be configured to perform processes, for example, corresponding to block 210 of process 200 described above with reference to FIG. 2, and blocks 410 and 422 of process 400 described above with reference to FIG. 4.

Displaying component 825 may be configured to perform processes for displaying versions of modified writing content and various selectable features via a provided user interface, for example, as depicted and described above with reference to user interfaces 500 and 600 of FIGS. 5-6.

Extracting component 826 may be configured to perform processes for extracting writing content from accessible sources, such as a professional user profile or a professional resume, for example, stored within storage corresponding to storage 120 described above with reference to FIG. 1.

In this example, memory 810 also includes prompt chain data 840 (for example, including prompt template data), user interface data 841, API gateway data 842, and application data 843.

The processing system 800 may be implemented in various ways. For example, the processing system 800 may be implemented within on-site, remote, or cloud-based computing devices.

The processing system 800 is just one example, and other configurations are possible. For example, in alternative aspects, aspects described with respect to the processing system 800 may be omitted, added, or substituted for alternative aspects.

### Example Clauses

Implementation examples are described in the following numbered clauses:

Clause 1: A method for generating iteratively modified writing content includes: receiving a request to enhance writing content from a user of a document-editing application; generating a first prompt chain configured to cause a language model to generate a modified version of the writing content, the first prompt chain comprising: a first prompt for generating an intermediate modified version of the writing content based on the writing content and an associated industry; and a second prompt for generating the modified version of the writing content based on the intermediate modified version of the writing content and a set of best practices of the associated industry; providing the first prompt chain to the language model; receiving the modified version of the writing content from the language model; storing the modified version of the writing content; and providing the modified version of the writing content to the user of the document-editing application within a list of selectable versions of the writing content.

Clause 2: The method of Clause 1, further comprising: receiving a second request from the user to further enhance the modified version of the writing content, wherein the received modified version of the writing content is edited prior to receiving the second request.

Clause 3: The method of Clause 2, further comprising generating a second prompt chain configured to cause the language model to generate a further modified version of the writing content based on the modified version of the writing content.

Clause 4: The method of any one of Clauses 1-3, further comprising: providing the second prompt chain to the language model; receiving, the further modified version of the writing content from the language model; storing the further modified version of the writing content; and providing the further modified version of the writing content to the user of the document-editing application within the list of selectable versions of the writing content.

Clause 5: The method of any one of Clauses 1-4, wherein the first prompt includes instructions for causing the language model to: determine the associated industry for the writing content; and generate the intermediate modified version of the writing content based on a set of best practices corresponding to the determined associated industry.

Clause 6: The method of any one of Clauses 1-5, wherein the second prompt comprises instructions for causing the language model to: in response to determining that one or more words of the intermediate modified version of the writing content conflict with the set of best practices, further modify the intermediate modified version of the writing content to generate the modified version of the writing content.

Clause 7: The method of any one of Clauses 1-6, wherein the first prompt chain and the second prompt chain are generated using shared prompt templates.

Clause 8: The method of any one of Clauses 1-7, wherein the first prompt is further configured to cause the language model to enhance one or more of clarity, professional tone, and impact of the writing content

Clause 9: The method of any one of Clauses 1-8, wherein the first prompt chain and the second prompt chain are provided to the language model via an application programming interface.

Clause 10: The method of any one of Clauses 1-9, wherein the list of selectable versions of the writing content is provided to the user of the document-editing application via a drop-down menu displayed within a user interface of the document-editing application.

Clause 11: A processing system, comprising means for performing a method in accordance with any one of Clauses 1-10.

Clause 12: A non-transitory computer-readable medium comprising computer-executable instructions that, when executed by one or more processors of a processing system, cause the processing system to perform a method in accordance with any one of Clauses 1-10.

Clause 13: A computer program product embodied on a computer-readable storage medium comprising code for performing a method in accordance with any one of Clauses 1-10.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for generating iteratively modified writing content, the method comprising:
receiving a request to enhance writing content from a user of a document-editing application;
generating a first prompt chain configured to cause a language model to generate a modified version of the writing content, the first prompt chain comprising:
a first prompt for generating an intermediate modified version of the writing content based on the writing content and an associated industry; and
a second prompt for generating the modified version of the writing content based on the intermediate modified version of the writing content and a set of best practices of the associated industry;
providing the first prompt chain to the language model;
receiving the modified version of the writing content from the language model;
storing the modified version of the writing content; and
providing the modified version of the writing content to the user of the document-editing application within a list of selectable versions of the writing content.

2. The method of claim 1, further comprising:
receiving a second request from the user to further enhance the modified version of the writing content,
wherein the received modified version of the writing content is edited prior to receiving the second request.

3. The method of claim 2, further comprising generating a second prompt chain configured to cause the language model to generate a further modified version of the writing content based on the modified version of the writing content.

4. The method of claim 3, further comprising:
providing the second prompt chain to the language model;
receiving, the further modified version of the writing content from the language model;
storing the further modified version of the writing content; and
providing the further modified version of the writing content to the user of the document-editing application within the list of selectable versions of the writing content.

5. The method of claim 1, wherein the first prompt includes instructions for causing the language model to:
determine the associated industry for the writing content; and
generate the intermediate modified version of the writing content based on a set of best practices corresponding to the determined associated industry.

6. The method of claim 1, wherein the second prompt comprises instructions for causing the language model to:
in response to determining that one or more words of the intermediate modified version of the writing content conflict with the set of best practices, further modify the intermediate modified version of the writing content to generate the modified version of the writing content.

7. The method of claim 3, wherein the first prompt chain and the second prompt chain are generated using shared prompt templates.

8. The method of claim 5, wherein the first prompt is further configured to cause the language model to enhance one or more of clarity, professional tone, and impact of the writing content.

9. The method of claim 4, wherein the first prompt chain and the second prompt chain are provided to the language model via an application programming interface.

10. The method of claim 4, wherein the list of selectable versions of the writing content is provided to the user of the document-editing application via a drop-down menu displayed within a user interface of the document-editing application.

11. The method of claim 10, further comprising:
receiving a selected version of the writing content from the drop-down menu;
displaying the selected version of the writing content to the user via the user interface of the document-editing application; and
generating a selectable icon for applying the displayed selected version to the writing content upon activation of the selectable icon by the user.

12. A processing system, comprising:
one or more memories comprising computer-executable instructions; and
one or more processors configured to execute the computer-executable instructions causing the processing system to:
receive a request to enhance writing content from a user of a document-editing application;
generate a first prompt chain configured to cause a language model to generate a modified version of the writing content, the first prompt chain comprising:
a first prompt for generating an intermediate modified version of the writing content based on the writing content and an associated industry; and
a second prompt for generating the modified version of the writing content based on the intermediate modified version of the writing content and a set of best practices of the associated industry;
provide the first prompt chain to the language model;
receive the modified version of the writing content from the language model;
store the modified version of the writing content; and
provide the modified version of the writing content to the user of the document-editing application within a list of selectable versions of the writing content.

13. The processing system of claim 12, wherein the one or more processors are further configured to cause the processing system to:
receive a second request from the user to further enhance the modified version of the writing content,
wherein the received modified version of the writing content is edited prior to receiving the second request.

14. The processing system of claim 13, wherein the one or more processors are further configured to cause the processing system to generate a second prompt chain configured to cause the language model to generate a further modified version of the writing content based on the modified version of the writing content.

15. The processing system of claim 14, wherein the one or more processors are further configured to cause the processing system to:
provide the second prompt chain to the language model;
receive, the further modified version of the writing content from the language model;
store the further modified version of the writing content; and
provide the further modified version of the writing content to the user of the document-editing application within the list of selectable versions of the writing content.

16. The processing system of claim 12, wherein the first prompt includes instructions for causing the language model to:
determine the associated industry for the writing content; and
generate the intermediate modified version of the writing content based on a set of best practices corresponding to the determined associated industry.

17. The processing system of claim 12, wherein the second prompt comprises instructions for causing the language model to: in response to determining that one or more words of the intermediate modified version of the writing content conflict with the set of best practices, further modify the intermediate modified version of the writing content to generate the modified version of the writing content.

18. The processing system of claim 16, wherein the first prompt is further configured to cause the language model to enhance one or more of clarity, professional tone, and impact of the writing content.

19. The processing system of claim 15, wherein the list of selectable versions of the writing content is provided to the user of the document-editing application via a drop-down menu displayed within a user interface of the document-editing application.

20. The processing system of claim 19, wherein the one or more processors are further configured to cause the processing system to:
receive a selected version of the writing content from the drop-down menu;
display the selected version of the writing content to the user via the user interface of the document-editing application; and
generate a selectable icon for applying the displayed selected version to the writing content upon activation of the selectable icon by the user.
